(19) United States
(12) Patent Application Publication
(10) Pub. No.: US 2026/0313418 A1
(43) Pub. Date: Oct. 8, 2026

(54) INTERACTIONS AND INTEROPERATIONS OF ANALYTICS FUNCTIONS IN A WIRELESS COMMUNICATIONS NETWORK

(71) Applicant: Lenovo (Singapore) Pte. Limited, Singapore (SG)

(72) Inventors: Konstantinos Samdanis, Munich (DE); Dimitrios Karampatsis, Ruislip (GB); Emmanouil Pateromichelakis, Viersen (DE)

(73) Assignee: Lenovo (Singapore) Pte. Limited, Singapore (SG)

(21) Appl. No.: 19/100,819

(22) PCT Filed: Sep. 15, 2022
(86) PCT No.: PCT/EP2022/075706

§ 371 Date: Feb. 3, 2025

(30) Foreign Application Priority Data
Aug. 4, 2022 (GR) 20220100643

(51) Int. Cl. H04W 24/10; H04L 41/14; H04L 43/06; H04W 16/18

(52) U.S. Cl. CPC H04W 24/10; H04L 41/14; H04L 43/06; H04W 16/18

(57) ABSTRACT

There is provided an apparatus comprising a receiver, a processor and a transmitter. The receiver is arranged to receive a first analytics request from a consumer. The processor is arranged to determine that counterpart analytics from a counterpart function are required to serve the first analytics request. The transmitter is arranged to send a counterpart analytics request to the counterpart function. The receiver is further arranged to receive a response to the counterpart analytics request from the counterpart function. The processor is further arranged to prepare an analytics response using the counterpart analytics. The transmitter is further arranged to send an analytics response to the consumer.

### FIELD

The subject matter disclosed herein relates generally to the field of implementing interactions and interoperations of analytics functions in a wireless communications network. This document defines an apparatus, a method in an apparatus, a central node, a method in a central node, a counterpart node and a method in a counterpart node.

### BACKGROUND

Data analytics in 3GPP are employed in the control plane, management plane and application enablement plane. In the control plane the Network Data Analytics Function (NWDAF) mainly focuses on UE(s), sessions, interaction with applications and services, while the Management Data Analytics (MDA) in management plane concentrates on resource management and network optimizations. Additionally, in an application enablement plane, an Application Data Analytics Enablement Server (ADAES) focuses on application server/session analytics and edge analytics.

These analytics can complement each other. For instance, the service experience Analytics ID (3GPP TS 23.288 v17.5.0) in NWDAF relies on RAN performance analytics or the slice load level Analytics ID (3GPP TS 23.288 v17.5.0) relies on network slice throughput and network slice traffic prediction (3GPP TS 28.104 v17.0.1), which can be offered from MDA. Equally MDA analytics such as SLS analysis (3GPP TS 28.104 v17.0.1) that require Quality of Experience (QoE) or UE mobility analytics (3GPP TS 23.288 v17.5.0). Another example is the derivation of application layer performance analytics (3GPP TR 23.700-36 v0.4.0) which takes as input the NWDAF and MDA analytics related to Quality of Service (QoS) and Performance Management (PM) data.

In US 2021/0083956 A1 a method is presented for acquiring information and interacting between the NWDAF and other 5G core Network Functions (NFs). In US 2021/0021494 A1 a method for MDA is presented considering the consumption of various data sources focusing on enhancing Self-Organized Network (SON) functions.

### SUMMARY

When an analytics function receives a consumer request related to an Analytics ID that relies on the output result of another Analytics ID from an inter-plane analytics function, i.e., NWDAF requires a MDAF Analytics ID output as input data or vice versa, there is hereby provided a means which tends to: (i) identify the appropriate inter-plane analytics function based on the desired capabilities that need to be analysed and determined considering the ones contained in the original consumer request, (ii) derive the analytics attribute and formulate a new analytics request automatically towards the respective counter plane analytics function. The Analytics ID information element is used to identify the type of supported analytics that are offered by an analytics function. The term inter-plane analytics refers to the exchange of analytics information among NFs, e.g., NWDAF, MDA, ADAES, that resides in a different network plane or network domain. A network plane or network domain refers to a technology domain, e.g., 5G core, radio, network management, and/or additionally it refers to an administrative domain, e.g., a domain that allow a network operator to divide a network into smaller parts to ease control and management. The terms MDA, MDAF and MDAS are used interchangeably in this document and have the same meaning, i.e., identifying management analytics function. The terms MDA MnS Producer refer to the capability of a MDAF to produce analytics and the MDA MnS Consumer refers to the capability of a MDAF to consume a 5C NF service and/or application enablement service and/or management service.

Disclosed herein are procedures for interactions and interoperations of analytics functions in a wireless communications network. Said procedures may be implemented by an apparatus, a method in an apparatus, a central node, a method in a central node, a counterpart node and a method in a counterpart node.

Accordingly, there is provided an apparatus comprising a receiver, a processor and a transmitter. The receiver is arranged to receive a first analytics request from a consumer. The processor is arranged to determine that counterpart analytics from a counterpart function are required to serve the first analytics request. The transmitter is arranged to send a counterpart analytics request to the counterpart function. The receiver is further arranged to receive a response to the counterpart analytics request from the counterpart function. The processor is further arranged to prepare an analytics response using the counterpart analytics. The transmitter is further arranged to send an analytics response to the consumer.

There is further provided a method in an apparatus, the method comprising: receiving a first analytics request from a consumer; determining that counterpart analytics from a counterpart function required to serve the first analytics request; and sending a counterpart analytics request to the counterpart function. The method further comprises receiving a response to the counterpart analytics request from the counterpart function; preparing an analytics response using the counterpart analytics; and sending an analytics response to the consumer.

There is further provided a central node comprising a receiver and a transmitter. The receiver is arranged to receive capability information from a plurality of counterpart nodes, the capability information defining the capability of the counterpart node to generate counterpart analytics. The receiver is further arranged to receive a request from an apparatus for capability information. The transmitter is arranged to send a capability report in response to the request.

There is further provided a method in a central node, the method comprising: receiving capability information from a plurality of counterpart nodes, the capability information defining the capability of the counterpart node to generate counterpart analytics; receiving a request from an apparatus for capability information; and sending a capability report in response to the request.

There is further provided a counterpart node comprising a transmitter arranged to send capability information to a central node, the capability information defining the capability of the counterpart node to generate counterpart analytics.

There is further provided a method in a counterpart node, the method comprising sending capability information to a central node, the capability information defining the capability of the counterpart node to generate counterpart analytics.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for interactions and interoperations of analytics functions in a wireless communications network will now be described, by way of example only, with reference to the accompanying drawings, in which:

FIG. 1 depicts an embodiment of a wireless communication system for implementing interactions and interoperations of analytics functions in a wireless communications network as described herein;

FIG. 2 shows a functional overview and interaction of an MDA with an NWDAF;

FIG. 3 depicts a user equipment apparatus that may be used for implementing the methods described herein;

FIG. 4 depicts further details of a network node that may be used for implementing the methods described herein;

FIG. 5 illustrates a method in an apparatus;

FIG. 6 illustrates a method in a central node;

FIG. 7 illustrates a method in a counterpart node;

FIG. 8 illustrates an inter-plane analytics example showing an analytics consumer that request analytics from a recipient analytics function that resides in a different domain;

FIG. 9 presents a flow chat of the inter-plane analytics request and response method; and

FIG. 10 illustrates a method of inter-plane analytics between ADAES and 3GPP domain analytics.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures Like numbers refer to like elements in all Figures.

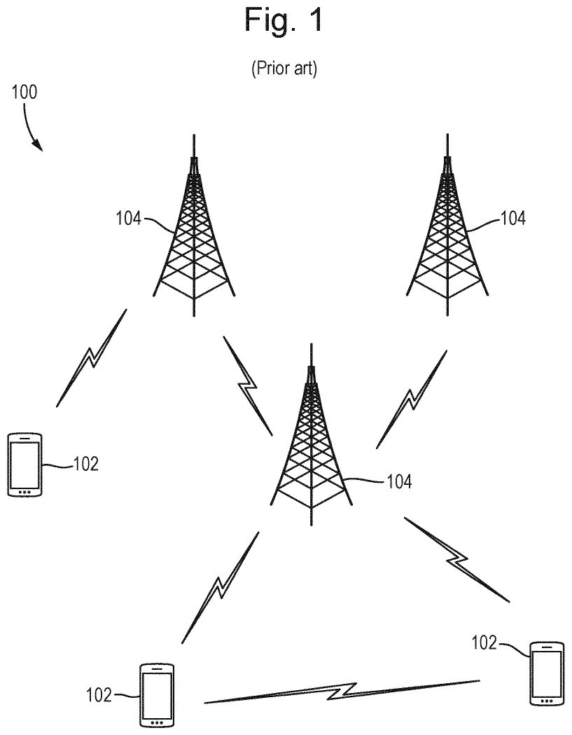

FIG. 1 depicts an embodiment of a wireless communication system 100 for implementing interactions and interoperations of analytics functions in a wireless communications network. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100. Remote unit 102 may be a user equipment apparatus 300, a consumer 210, or an analytics consumer 810, 910, 1010 as described herein. The network unit 104 may comprise a network node 400, a consumer 210, an analytics consumer 810, 910, 1010, a recipient analytics function 820, 920, an analytics function 870, inter-plane analytics function 940, a centralized server 950, an other data source 960, ADAES 1020 as described herein.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

Data analytics in 3GPP are employed in the control plane, management plane and application enablement plane. In the control plane the Network Data Analytics Function (NWDAF) mainly focuses on UE(s), sessions, interaction with applications and services, while the Management Data Analytics (MDA) in management plane concentrates on resource management and network optimizations. Additionally, in an application enablement plane, an Application Data Analytics Enablement Server (ADAES) focuses on application server/session analytics and edge analytics.

These analytics can complement each other. For instance, the service experience Analytics ID (3GPP TS 23.288 v17.5.0) in NWDAF relies on RAN performance analytics or the slice load level Analytics ID (3GPP TS 23.288 v17.5.0) relies on network slice throughput and network slice traffic prediction (3GPP TS 28.104 v17.0.1), which can be offered from MDA. Equally MDA analytics such as SLS analysis (3GPP TS 28.104 v17.0.1) that require Quality of Experience (QoE) or UE mobility analytics (3GPP TS 23.288 v17.5.0). Another example is the derivation of application layer performance analytics (3GPP TR 23.700-36 v0.4.0) which takes as input the NWDAF and MDAF analytics related to Quality of Service (QoS) and PM data.

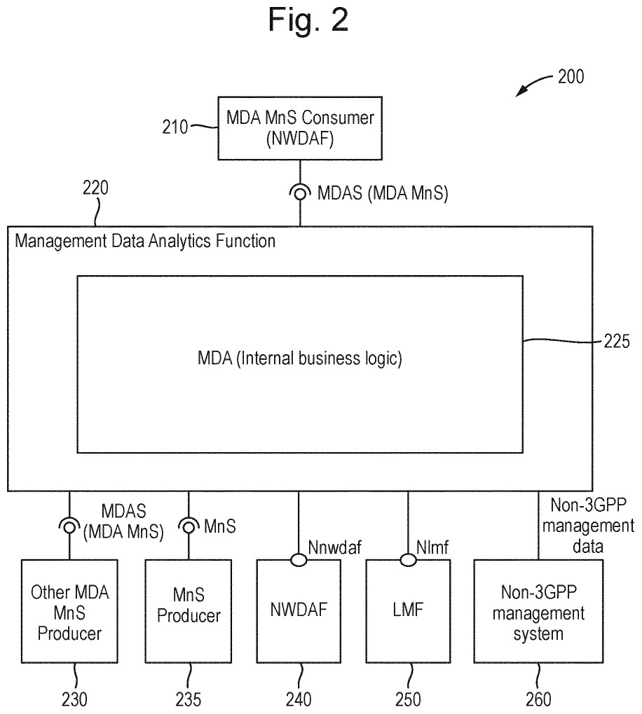

FIG. 2 shows a functional overview and interaction of an MDA with an NWDAF. This figure illustrates how a Management Data Analytics function (MDA function) can interact with a Network Data Analytics Function (NWDAF) and can exchange data as input and output via the means of Service Based Architecture (SBA) and Service Based management Architecture (SBMA).

Service Based Architecture (SBA) enables the NWDAF to: (i) subscribe to MDA Management Service (MnS) Producer (MDA function that produces analytics) and (ii) provide NWDAF analytics output to MDA MnS Consumer (which can be a management function including the MDA function that produces analytics). Service Based management Architecture (SBMA) enables: (1) MDA MnS producer to provide analytics to NWDAF and (ii) MDA MnS consumer to subscribe to NWDAF.

FIG. 2 shows an MDA MnS Consumer 210, an MDA function 220, an other MDA MnS Producer 230, an MnS producer 235, an NWDAF 240, an LMF 250, and a non-3GPP management system 260. Each of the MDA MnS Consumer 210, the other MDA MnS Producer 230, the MnS producer 235, the NWDAF 240, the LMF 250, and the non-3GPP management system 260 communicate with the MDA function 220 via a respective interface. The MDA function 220 comprises MDA internal business logic 225.

When a consumer of NWDAF or MDA issues a request, it specifies certain requirements related to when an analytics report shall be provided, in terms of area of interest, target UEs or network objects (e.g., NF), time scheduling, event conditions (e.g., when the NF load surpasses a given threshold), etc.

The provision of analytics can rely on the output result of other analytics services or analytics functions from different technology domains, referred to as inter-plane analytics or cross-domain analytics. The terminology of inter-plane, cross-domain and counter-plane are used in this document interchangeably.

Inter-plane analytics can be defined as a first analytics service, which requires as input from a second analytics service, wherein the first and/or second analytics service is a NWDAF, MDAS, ADAES service or a combination thereof. In the context of this document inter-plane analytics are considered to reside inside a single PLMN and are used without roaming considerations.

In case of a need for inter-plane analytics, i.e., when a NWDAF Analytics ID request relies on MDA output or vice versa, a consumer request at the recipient analytics function shall introduce a subsequent subscription towards the appropriate inter-plane analytics counterpart function. However, currently there is no means to perform this automatically. The requirements of an analytics request are only explicitly stated by the consumer and there is no means to be derived based on the analytics requirements once received by an analytics function. Typical examples are provided below:

NWDAF Analytics ID=“Network Performance” (3GPP TS 23.288 v17.5.0) relies on: (i) OAM statistics on RAN status (up/down) that can be obtained from MDA Analytics ID=“CoverageAnalytics.CoverageProblemAnalysis” (3GPP TS 28.104 v17.0.1), and (ii) load (i.e., Radio Resource utilization) that can be obtained from MDA Analytics ID=“SLSAnalysis.NetworkSliceTrafficAnalysisNetwork” (3GPP TS 28.104 v17.0.1).

MDA Analytics ID=“MDAAssistedFaultManagement.FailurePrediction” (3GPP TS 28.104 v17.0.1) relies on NWDAF Analytics ID=“Service Experience” (3GPP TS 23.288 v17.5.0) to obtain control plane analysis insight.

The recipient analytics function has no means for issuing a subsequent request based on the initial one received from the consumer, because of two main gaps on: (i) deriving the analytics requirements in order to formulate the new analytics request towards the analytics function on the counter plane and (ii) identifying the appropriate analytics function on the counter plane that would be responsible for providing the complementing analytics.

These two processes are interrelated since the selection of the counter plane analytics function will influence, i.e., introduce an upper bound on, the capability (e.g., area of interest, or time scheduling) related to the deriving requirements of the new analytics request towards that counter plane analytics function.

Another example of inter-plane analytics considering the application enablement plane relates to the following ADAE provided analytics services (as discussed in 3GPP TR 23.700-36 v0.4.0). As can be seen in table 1 below, some application layer analytics services use as inputs NWDAF analytics or MDAF analytics. Furthermore, the consumer of such analytics from ADAES can also be NWDAF (e.g., for DN performance analytics, NWDAF instead of receiving raw service experience data, it can receive statistics from ADAES (acting as AF)).

The use cases listed below require inter-plane or cross-domain analytics interactions, and pose some issues related to the coordination that is required among analytics functions to ensure meeting the consumer's requirements for a given area of interest or UEs and time horizon.

This document defines a solution that tends to facilitate configuring and coordination of input parameters for requesting an inter-plane analytics service to ensure meeting a consumer's requirements. Further, certain arrangements presented herein facilitate the selection of an appropriate inter-plane analytics function to provide inputs for an analytics service. Further still, there is provided a solution that tends to coordinate parameters, e.g., the timing and coverage parameters, etc., for the inter-plane analytics service.

TABLE 1
Application Data Analytics Enablement analytics services

| | | Data Collection | | Type of |
|---|---|---|---|---|
| Analytics Event | Inputs | Sources | Analytics Outputs | analytics |
| VAL server | per VAL server | 1. VAL UE | Analytics on application | Prediction, |
| performance | performance | 2. VAL Server | QoS metrics per VAL | statistics |
| analytics | measurements, | 3. OAM | server | |
| | historical data/stats for | 4. 5GC (NWDAF, | | |
| | VAL server | NEF) | | |
| | performance, network/ | | | |
| | KPI monitoring from | | | |
| | 5GS | | | |
| edge load | edge platform load | 1. OAM/MDAS | 1. stats/predictions on | Prediction, |
| analytics | data, EAS/EES load | 2. 5GC/NWDAF | the EDN load | statistics |
| | data, DN performance | 3. SEALDD server | conditions, | |
| | analytics, UPF load | 4. EES | 2. EES or EAS load | |
| | analytics | 5. EAS | stats/predictions, 3. | |
| | | 5. MEP/RNIS | recommendation for | |
| | | | pro-active EAS | |
| | | | relocation trigger | |
| Slice related | per slice | 1. OAM or NSCE | Statistics/prediction for | Prediction, |
| performance | measurements and | 2. 5GC/NWDAF | the VAL application | statistics |
| analytics | analytics, application | 3. VAL UEs | QoS for one or more | |
| | session performance | | requested S- | |
| | analytics, historical | | NSSAIs/NSIs | |
| | data on slice | | | |
| | information | | | |
| Location | UE mobility analytics, | 1. SEAL LMS/FLS | a predictive location | Prediction |
| accuracy | UE location reports and | 2. 5GC/NWDAF | accuracy sustainability | |
| analytics | achieved accuracy, | 3. A-ADRF | or change indication | |
| | historical location | | | |
| | accuracy statistics for | | | |
| | target VAL service area | | | |
| | or VAL UE | | | |
| Slice | per slice | 1. SEAL NSCE | Statistics for the | Statistics |
| configuration | measurements and | 2. OAM | network slice | |
| recommendation | analytics, historical | 3. NWDAF | configuration | |
| | data on slice | 4. A-ADRF | recommendation for | |
| | information | | one or more requested | |
| | | | S-NSSAIs | |

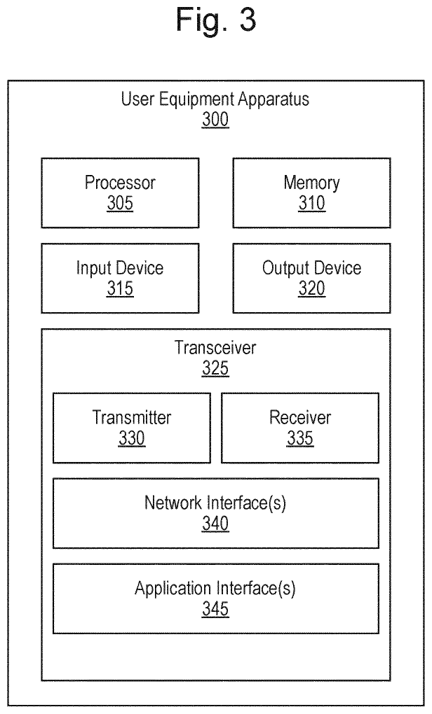

FIG. 3 depicts a user equipment apparatus 300 that may be used for implementing the methods described herein. The user equipment apparatus 300 is used to implement one or more of the solutions described herein. The user equipment apparatus 300 is in accordance with one or more of the user equipment apparatuses described in embodiments herein. User equipment apparatus 300 may be a remote unit 102, an other data source 960, an ADAES 1020, a consumer 210, or an analytics consumer 810, 910, 1010 as described herein. The user equipment apparatus 300 includes a processor 305, a memory 310, an input device 315, an output device 320, and a transceiver 325.

The input device 315 and the output device 320 may be combined into a single device, such as a touchscreen. In some implementations, the user equipment apparatus 300 does not include any input device 315 and/or output device 320. The user equipment apparatus 300 may include one or more of: the processor 305, the memory 310, and the transceiver 325, and may not include the input device 315 and/or the output device 320.

As depicted, the transceiver 325 includes at least one transmitter 330 and at least one receiver 335. The transceiver 325 may communicate with one or more cells (or wireless coverage areas) supported by one or more base units. The transceiver 325 may be operable on unlicensed spectrum. Moreover, the transceiver 325 may include multiple UE panels supporting one or more beams. Additionally, the transceiver 325 may support at least one network interface 340 and/or application interface 345. The application interface(s) 345 may support one or more APIs. The network interface(s) 340 may support 3GPP reference points, such as Uu, N1, PC5, etc. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a central processing unit (“CPU”), a graphics processing unit (“GPU”), an auxiliary processing unit, a field programmable gate array (“FPGA”), or similar programmable controller. The processor 305 may execute instructions stored in the memory 310 to perform the methods and routines described herein. The processor 305 is communicatively coupled to the memory 310, the input device 315, the output device 320, and the transceiver 325.

The processor 305 may control the user equipment apparatus 300 to implement the user equipment apparatus behaviors described herein. The processor 305 may include an application processor (also known as “main processor”) which manages application-domain and operating system (“OS”) functions and a baseband processor (also known as “baseband radio processor”) which manages radio functions.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to implement a traffic category field as described herein. The memory 310 may also store program code and related data, such as an operating system or other controller algorithms operating on the apparatus 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 320 may include a wearable display separate from, but communicatively coupled to, the rest of the user equipment apparatus 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 communicates with one or more network functions of a mobile communication network via one or more access networks. The transceiver 325 operates under the control of the processor 305 to transmit messages, data, and other signals and also to receive messages, data, and other signals. For example, the processor 305 may selectively activate the transceiver 325 (or portions thereof) at particular times in order to send and receive messages.

The transceiver 325 includes at least one transmitter 330 and at least one receiver 335. The one or more transmitters 330 may be used to provide uplink communication signals to a base unit of a wireless communications network. Similarly, the one or more receivers 335 may be used to receive downlink communication signals from the base unit. Although only one transmitter 330 and one receiver 335 are illustrated, the user equipment apparatus 300 may have any suitable number of transmitters 330 and receivers 335. Further, the transmitter(s) 330 and the receiver(s) 335 may be any suitable type of transmitters and receivers. The transceiver 325 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 325, transmitters 330, and receivers 335 may be implemented as physically separate components that access a shared hardware resource and/or software resource, such as for example, the network interface 340.

One or more transmitters 330 and/or one or more receivers 335 may be implemented and/or integrated into a single hardware component, such as a multi-transceiver chip, a system-on-a-chip, an Application-Specific Integrated Circuit (“ASIC”), or other type of hardware component. One or more transmitters 330 and/or one or more receivers 335 may be implemented and/or integrated into a multi-chip module. Other components such as the network interface 340 or other hardware components/circuits may be integrated with any number of transmitters 330 and/or receivers 335 into a single chip. The transmitters 330 and receivers 335 may be logically configured as a transceiver 325 that uses one more common control signals or as modular transmitters 330 and receivers 335 implemented in the same hardware chip or in a multi-chip module.

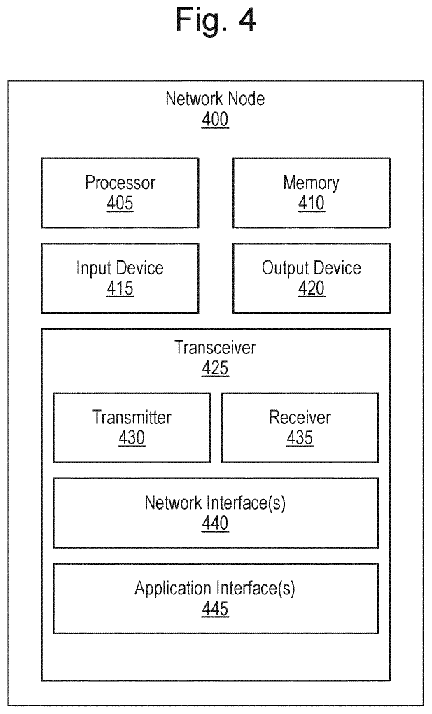

FIG. 4 depicts further details of the network node 400 that may be used for implementing the methods described herein. The network node 400 may comprise a consumer 210, an analytics consumer 810, 910, 1010, a recipient analytics function 820, 920, an analytics function 870, inter-plane analytics function 940, a centralized server 950, an other data source 960, or an ADAES 1020 as described herein. The network node 400 includes a processor 405, a memory 410, an input device 415, an output device 420, and a transceiver 425.

The input device 415 and the output device 420 may be combined into a single device. In some implementations, the network node 400 does not include any input device 415 and/or output device 420. The network node 400 may include one or more of: the processor 405, the memory 410, and the transceiver 425, and may not include the input device 415 and/or the output device 420.

As depicted, the transceiver 425 includes at least one transmitter 430 and at least one receiver 435. Here, the transceiver 425 communicates with one or more remote units 200. Additionally, the transceiver 425 may support at least one network interface 440 and/or application interface 445. The application interface(s) 445 may support one or more APIs. The network interface(s) 440 may support 3GPP reference points, such as Uu, N1, N2 and N3. Other network interfaces 440 may be supported, as understood by one of ordinary skill in the art.

The processor 405 may include any known controller capable of executing computer-readable instructions and/or capable of performing logical operations. For example, the processor 405 may be a microcontroller, a microprocessor, a CPU, a GPU, an auxiliary processing unit, a FPGA, or similar programmable controller. The processor 405 may execute instructions stored in the memory 410 to perform the methods and routines described herein. The processor 405 is communicatively coupled to the memory 410, the input device 415, the output device 420, and the transceiver 425.

The memory 410 may be a computer readable storage medium. The memory 410 may include volatile computer storage media. For example, the memory 410 may include a RAM, including dynamic RAM (“DRAM”), synchronous dynamic RAM (“SDRAM”), and/or static RAM (“SRAM”). The memory 410 may include non-volatile computer storage media. For example, the memory 410 may include a hard disk drive, a flash memory, or any other suitable non-volatile computer storage device. The memory 410 may include both volatile and non-volatile computer storage media.

The memory 410 may store data related to establishing a multipath unicast link and/or mobile operation. For example, the memory 410 may store parameters, configurations, resource assignments, policies, and the like, as described herein. The memory 410 may also store program code and related data, such as an operating system or other controller algorithms operating on the network node 400.

The input device 415 may include any known computer input device including a touch panel, a button, a keyboard, a stylus, a microphone, or the like. The input device 415 may be integrated with the output device 420, for example, as a touchscreen or similar touch-sensitive display. The input device 415 may include a touchscreen such that text may be input using a virtual keyboard displayed on the touchscreen and/or by handwriting on the touchscreen. The input device 415 may include two or more different devices, such as a keyboard and a touch panel.

The output device 420 may be designed to output visual, audible, and/or haptic signals. The output device 420 may include an electronically controllable display or display device capable of outputting visual data to a user. For example, the output device 420 may include, but is not limited to, an LCD display, an LED display, an OLED display, a projector, or similar display device capable of outputting images, text, or the like to a user. As another, non-limiting, example, the output device 420 may include a wearable display separate from, but communicatively coupled to, the rest of the network node 400, such as a smart watch, smart glasses, a heads-up display, or the like. Further, the output device 420 may be a component of a smart phone, a personal digital assistant, a television, a table computer, a notebook (laptop) computer, a personal computer, a vehicle dashboard, or the like.

The output device 420 may include one or more speakers for producing sound. For example, the output device 420 may produce an audible alert or notification (e.g., a beep or chime). The output device 420 may include one or more haptic devices for producing vibrations, motion, or other haptic feedback. All, or portions, of the output device 420 may be integrated with the input device 415. For example, the input device 415 and output device 420 may form a touchscreen or similar touch-sensitive display. The output device 420 may be located near the input device 415.

The transceiver 425 includes at least one transmitter 430 and at least one receiver 435. The one or more transmitters 430 may be used to communicate with the UE, as described herein. Similarly, the one or more receivers 435 may be used to communicate with network functions in the PLMN and/or RAN, as described herein. Although only one transmitter 430 and one receiver 435 are illustrated, the network node 400 may have any suitable number of transmitters 430 and receivers 435. Further, the transmitter(s) 430 and the receiver(s) 435 may be any suitable type of transmitters and receivers.

Accordingly, there is provided an apparatus comprising a receiver, a processor and a transmitter. The receiver is arranged to receive a first analytics request from a consumer. The processor is arranged to determine that counterpart analytics from a counterpart function, which are required to serve the first analytics request. The transmitter is arranged to send a counterpart analytics request to the counterpart function. The receiver is further arranged to receive a response to the counterpart analytics request from the counterpart function. The processor is further arranged to prepare an analytics response using the counterpart analytics. The transmitter is further arranged to send an analytics response to the consumer.

The apparatus may be further arranged to use self-derived analytics. The analytics response may be prepared using both the self-derived analytics and the counterpart analytics. Self-derived analytics may comprise analytics derived by the apparatus. Self-derived analytics may comprise analytics derived by the apparatus using locally available information. Self-derived analytics may be analytics derived in a domain local to the apparatus. Self-derived analytics may comprise analytics derived by the apparatus based on raw data. Raw data is information provided by network sources based on local measurements.

Such an apparatus tends to facilitate configuring and coordination of input parameters for requesting an inter-plane analytics service to ensure meeting a consumer's requirements. This may facilitate the selection of an appropriate inter-plane analytics function to provide inputs for an analytics service. Further, this may provide a solution that tends to coordinate parameters, e.g., the timing and coverage parameters, etc., for the inter-plane analytics service.

The processor may be further arranged to determine attributes required in the counterpart analytics request based on the first analytics request from the consumer.

The receiver may be further arranged to receive information on the capabilities of the counterpart function. The apparatus may be arranged to discover the capabilities of the counterpart function. The processor may be further arranged to discover the capabilities of the counterpart function from the counterpart function or another node. The transmitter may be arranged to send a capability discovery message to the counterpart function or another node. The another node may be a centralized server.

The capabilities may include the expected computational latency, communication latency, reporting samples type and analytics type. These capabilities complement the state of the art capabilities used that include the Analytics Id, AI/ML model Id, confidence level, reporting method, area of interest, target UEs, network and management objects, filtering conditions, (e.g., threshold crossing). An AI/ML model may comprise an artificial intelligence model and/or a machine learning model.

The processor may be arranged to negotiate analytics requirements with the consumer. The processor may be further arranged to negotiate the requirements of the first analytics request with the consumer if a selection of an optimal counterpart function cannot satisfy the requirements of the first analytics request.

The apparatus and the counterpart function may reside on different network planes. The apparatus and the counterpart function may reside on the same network plane, but on different domains.

The counterpart analytics request may comprise at least one parameter selected from the following group: Analytics ID, AI/ML Model ID, time schedule, reporting time window, reporting analytics sample type, confidence level, analytics type, reporting method, target area, target users, target network objects, and reporting filtering conditions.

The first analytics request may comprise at least one parameter, and the processor may be further arranged to: map parameters from the first request to parameters in the counterpart analytics request; derive parameter relations; and/or translate one type of parameter to another. The mapping may be based on pre-configured information and/or based on parameter matching.

The processor may be further arranged to translate one attribute type from the first analytics request related to target UEs into a geographical area. The processor may be further arranged to translate one attribute type related to geographical area into any UE identity. The processor may be further arranged to identify containment relations among management services and counterpart functions and vice versa.

The processor may be further arranged to calculate a relative time schedule for reporting by the counterpart function, the relative time schedule calculated considering at least one of a processor load in the counterpart function, a storage load in the counterpart function and the communication latency between the counterpart function and the apparatus.

The processor may be further arranged to derive a format of a machine learning model input, by considering at least one of: the reporting time window; analytics samples; and/or confidence degree. The machine learning (ML) model may comprise an artificial intelligence (AI) model. The processor may be further arranged to identify the machine learning model and the related reporting time window, analytics samples, and confidence degree.

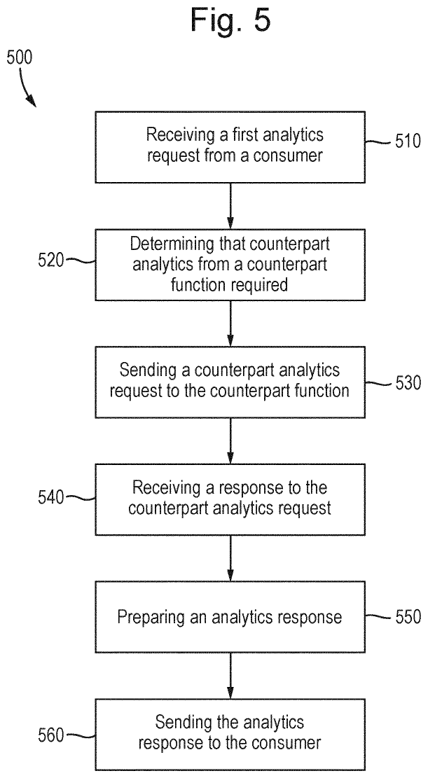

FIG. 5 illustrates a method 500 in an apparatus. The method 500 comprises receiving 510 a first analytics request from a consumer, and determining 520 that counterpart analytics from a counterpart function required to serve the first analytics request. The method 500 further comprises sending 530 a counterpart analytics request to the counterpart function, and receiving 540 a response to the counterpart analytics request from the counterpart function. The method 500 further still comprises preparing 550 an analytics response using the counterpart analytics, and sending 560 the analytics response to the consumer.

There is further provided a central node comprising a receiver and a transmitter. The receiver is arranged to receive capability information from a plurality of counterpart nodes, the capability information defining the capability of the counterpart node to generate counterpart analytics. The receiver is further arranged to receive a request from an apparatus for capability information. The transmitter is arranged to send a capability report in response to the request.

The centralized node facilitates an apparatus discovering the capabilities of a counterpart function. The capability report may comprise the capability information for at least one counterpart node. The capability report may comprise at least one counterpart function that meets capability requirements defined in the request for capability information. The capabilities may include the expected computational latency, communication latency, reporting samples type and analytics type. These capabilities complement the state of the art capabilities used that include the Analytics Id, AI/ML model Id, confidence level, reporting method, area of interest, target UEs, network and management objects, filtering conditions, (e.g., threshold crossing). The capability report may carry a set of information or IDs related to counterpart analytics functions.

Such a central node tends to facilitate configuring and coordination of input parameters for requesting an inter-plane analytics service to ensure meeting a consumer's requirements. This may facilitate the selection of an appropriate inter-plane analytics function to provide inputs for an analytics service. Further, this may provide a solution that tends to coordinate parameters, e.g., the timing and coverage parameters, etc., for the inter-plane analytics service.

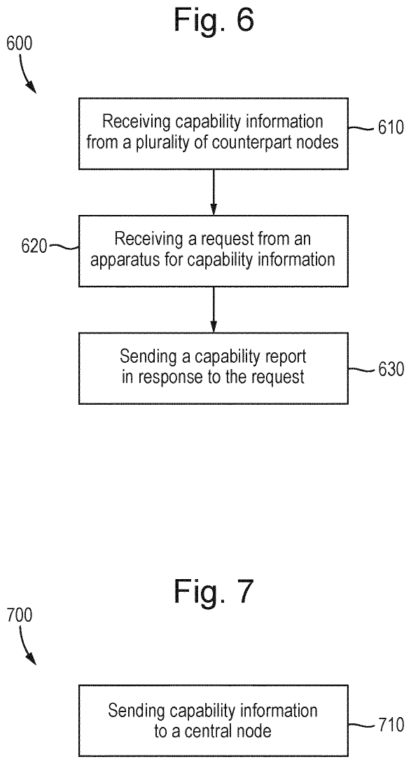

FIG. 6 illustrates a method 600 in a central node. The method 600 comprises receiving 610 capability information from a plurality of counterpart nodes, the capability information defining the capability of the counterpart node to generate counterpart analytics. The method 600 further comprises receiving 620 a request from an apparatus for capability information; and sending 630 a capability report in response to the request.

The request for capability information may indicate to the central node a particular counterpart analytics function. The capability report may also carry a set of information or IDs related to counterpart analytics functions.

There is further provided a counterpart node comprising a transmitter arranged to send capability information to a central node, the capability information defining the capability of the counterpart node to generate counterpart analytics.

FIG. 7 illustrates a method 700 in a counterpart node. The method 700 comprising sending 710 capability information to a central node, the capability information defining the capability of the counterpart node to generate counterpart analytics. The counterpart node may send the capability information to the central node. The counterpart node may send the capability information to the central node periodically or upon an event, e.g., threshold crossing, or upon determining that a UE starts to move. The counterpart node may send the capability information to the central node in response to a request from the central node. The request from the central node may be triggered by an initialization procedure. The request from the central node may be sent periodically.

The solution described herein relates to the case where an analytics service relies on a further analytics output (such as from NWDAF, MDAF, ADAES), and there is a need to request inter-plane analytics once an analytics consumer request is received in an analytic function, i.e., when a NWDAF Analytics ID request relies on MDA output or vice versa. In other words, there is provided a method that autonomously issues a subsequent analytics request towards the desired inter-plane analytics counterpart function.

To achieve this, a consumer request may be analysed and processed by the recipient analytics function in order to: (i) formulate automatically the subsequent subscription request towards the discovered analytics counterpart function and (ii) perform the discovery of the appropriate inter-plane analytics counterpart function needed. The inter-plane Analytics ID type selection can be based on the data input that is needed and this relation can be pre-configured.

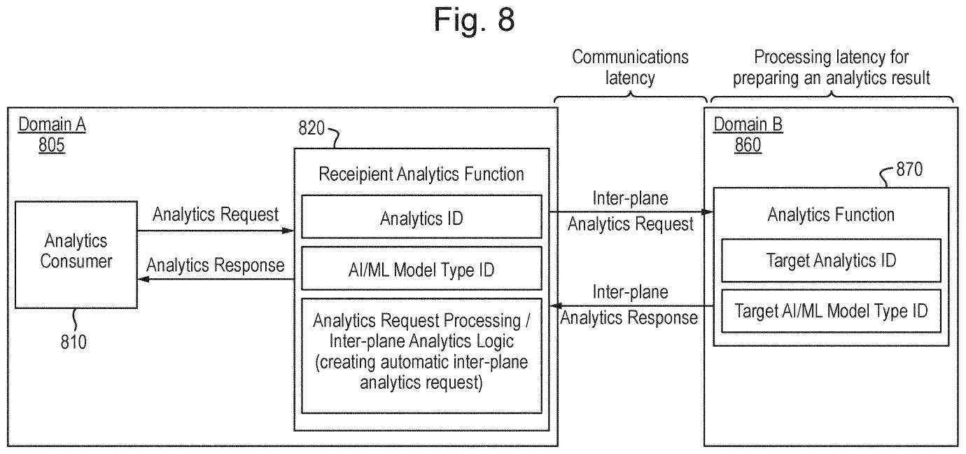

FIG. 8 illustrates an inter-plane analytics example showing an analytics consumer that request analytics from a recipient analytics function that resides in a different domain. The different domain may be on the control plane or management plane or application enablement plane. Domain A 805 comprises an analytics consumer 810, and a recipient analytics function 820. Domain B 860 comprises an analytics function 870.

The recipient analytics function 820 provides processing of the inter-plane analytics request or in other words provides the inter-plane analytics logic to select and automatically derive the requirements or otherwise the attributes related to an inter-plane analytics request (that is essentially an analytics request that is issued automatically) towards the corresponding inter-plane analytics function 870.

FIG. 8 also shows some key selection capabilities for choosing an inter-plane analytics function 870 including the Analytics ID and AI/ML Model type (including AI/ML Model specifics) as well as the estimation of the communication and processing latency that relates to the capability of supporting a specific analytics type result, e.g., real-time, near-real time or non-real time.

The recipient analytics function 820 firstly analyses based on the Inter-plane Analytics Logic and processes the requirements of the consumer request. It then automatically derives the corresponding requirements or attributes related to the inter-plane analytics request that is going to issue towards the counterpart inter-plane analytics function 870 that may include and is not limited to the following examples. The inter-plane logic or process and the automatic way of selecting and/or deriving any of the following attributes: Target Analytics ID; Target AI/ML Model type; Relative time schedule; Reporting time window; Reporting analytics samples; Confidence level; Analytics type; Reporting method; Area of Interest; Target UE(s); Network or management objects; Filtering conditions; or any combination thereof. These attributes will be discussed in detail in the following paragraphs.

Target Analytics ID: It refers to the desired inter-plane analytics function capability, e.g., to be capable to produce UE mobility analytics, NF load analytics, slice throughput analytics, etc. This is automatically selected using a mapping procedure, e.g., based on a pre-configured table, considering the necessary type of inputs. Optionally, the consumer may indicate (e.g., explicitly that needs to use the following type of AI/ML Model) or can be a further mapping, e.g., based on a pre-configured table, for selecting the desired Target AI/ML Model type (e.g., regression, decision tree, etc.) to be used and in that case, it shall also serve as another inter-plane analytics function selection capability.

Relative time schedule: Considering the time schedule indicated by the consumer, the recipient analytics function shall be able to estimate the corresponding time schedule (explicit calculate or access repository information) taking into account the upper bound time needed to receive the respond from other inter-plane analytics function that relies upon. To achieve this each analytics function can register in a repository or centralized entity, e.g., Domain Name Server (DNS), its capability in terms of the upper bound time in preparing an analytics result based on the available CPU and storage resources and the current workload. Alternative each analytics function can respond to the requesting inter-plane analytics function, its capability in terms of the upper bound time in preparing an analytics result based on the available CPU and storage resources and the current workload. Each requesting analytics function needs to have an estimation of the communications latency in receiving analytics from the requesting inter-plane analytics function, e.g., this can be achieved by sending a round trip probe message to estimate the expected latency.

Reporting time window: It refers to the desired reporting time window, i.e., indicates the start time and stop time for analytics results contained in the report, from the inter-plane analytics function. The start and stop time depend on the AI/ML Model type in the recipient analytics function and can be calculated or be preconfigured on a table.

Reporting analytics samples: This indicates how the reporting of the analytics samples shall be presented, e.g., average value, min-max value, pdf, discrete time-based samples, etc., and depends on the AI/ML Model type in the recipient analytics function. The selection of the AI/ML Model type (e.g., based on a pre-configured table) also include the required sampling.

Confidence level: Indicates the desired confidence level (i.e., confidence of predicting a result based on the current data) that the recipient analytics function needs (i.e., for its Analytics ID and AI/ML Model type) related to the analytics result from the Target Analytics ID and the corresponding Target AI/ML Model type.

Analytics type: Considering the analytics type requested from the consumer, i.e., real-time, near-real time or non-real time, the recipient analytics considering also its Analytics ID and AI/ML Model type needs, shall request the desired analytics type from the selected inter-plane analytics function. The selection shall be based on a correlation of: (i) the customer indication, (ii) the recipient analytics function needs to feed its Analytics ID and AI/ML Model type, (iii) on the relative time schedule from each candidate inter-plane analytics function and (iv) on the reporting method capability related to the inter-plane analytics function. For example, a real-time analytics type requested from a consumer can only be satisfied if the recipient analytics function Analytics ID and AI/ML Model type work with real-time data and can receive real-time data from the inter-plane analytics function via stream-based reporting that assures real-time data delivery.

Reporting method: It refers to the way of receiving the analytics result from the inter-plane analytics function. For example, MDAF may request NWDAF: (i) an on-demand, i.e., immediate, one-time request or (ii) a subscription based on a specified time schedule and/or other filtering criteria, e.g., if NF load surpass a threshold limit. The analytics result is carried for both cases using notifications. On another example, NWDAF may request MDAF to: (i) report in a file format (based on a specified time schedule and/or other filtering criteria) when the output is of a greater size/volume, or (ii) stream-based reporting that suits real-time data (i.e., establishes connectivity and transmits an analytics result once it is ready immediately) or (iii) report in notification based (considering a specified time schedule and/or other filtering criteria) if the output data is maintained first in a data storage entity, where the consumer receives a notification to fetch the data. The reporting method is selected in correlation with the requested analytics type, the relative time schedule and by considering the data volume and the recipient of the analytics result.

Area of Interest: Can be explicitly specified by the consumer and in this case the recipient analytics function maps and requests the same area capability, i.e., be capable to produce analytics in the specified area, to the inter-plane analytics function.

Target UE(s): It refers to different aspects with respect to the control or management or application plane. The control plane focuses on a particular UE ID (Subscription Permanent Identifier-SUPI), the management plane considers the average UE in a particular location, while the application plane focuses on the application client residing in the UE. Specifically, in case where NWDAF needs MDA output, e.g., resource utilization prediction, in relation to a UE or a group of UE, that reside in a particular area, it needs to translate the location of UE(s) into an area, e.g., in the form of cells or TAs. In case where MDA MnS producer needs NWDAF output, it needs to request analytics for any UE in a particular area of interest, i.e., cells or TAs. In case of the ADAES, it needs to request analytics in particular application clients within any UE residing in a certain area of interest, i.e., cells or TAs.

Network or management objects: Refers to NFs when requesting inter-plane analytics from the control plane and is discovered based on the interaction with NRF, application components and services on the application plane or an MnS when requesting inter-plane analytics from the management plane and relies on interaction with a DNS or centralized discovery server that contains the relation of the requested IP address with the desired MnS objects. The selection for each case can be based on identifying containment relations with the assistance of repositories or other discovery means, e.g., requesting object relations directly.

Filtering conditions: Refers to the conditions included in a consumer request, which indicate the report triggering criteria. The recipient analytics function needs to identify where filtering conditions shall be applied, (i.e., match considering the operation capabilities of its own and target analytics function) and relate to the requesting inter-plane analytics if that is the case. For example, a consumer request towards MDA may indicate reporting criteria when a UE set starts moving towards neighboring cells, a condition that can easily be realized in the control plane and shall be included in the respective inter-plane analytics request.

It shall be noted that any combination of the attributes presented above can also assist as criteria for the recipient analytics function that receives the consumer request to decide whether it shall request an inter-plane analytics function to report the desired analytics result, e.g., considering the time schedule and confidence of prediction received, or it can alternatively collect the desired raw data from the original inter-plane sources and calculate the result locally (e.g., in case the desired conditions can be met in this way).

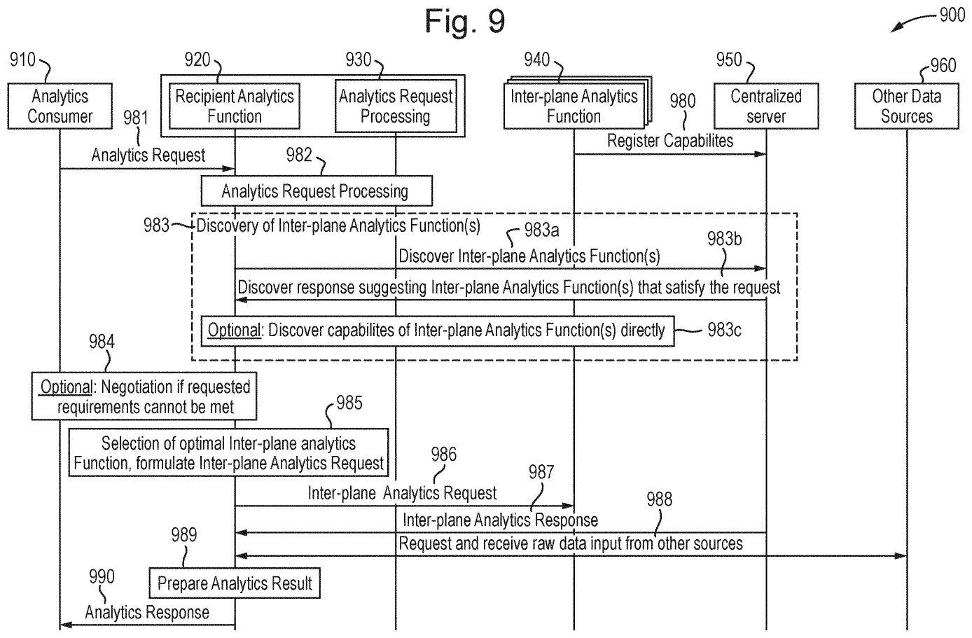

FIG. 9 presents a flow chat of the inter-plane analytics request and response method 900. FIG. 9 shows an Analytics Consumer 910, a Recipient Analytics Function 920, an Analytics Request Processing function 930, Inter-plane Analytics Function 940, a centralized server 950, and other data sources 960. The Analytics Request Processing 930 may comprise Inter-plane Analytics Logic. The Centralized Server 950 may comprise an NRF or a DNS.

At 980, initially an Inter-plane Analytics Functions 940 register their capabilities (i.e., analytics result calculation latency, analytics type, reporting time window, reporting samples, support of reporting method) to a centralized repository like NRF or DNS. In NRF an Inter-plane analytics functions 940 can register all capabilities, while in DNS only its IP address with minimal other capabilities. Any other repository that can store any number of capabilities allowing a hybrid discovery is possible.

At 981, an analytics consumer 910 issues a request using either: (i) the on-demand request or subscription method if the recipient analytics function 920 is NWDAF described in 3GPP TS 23.288 v17.5.0 or (ii) the MDA Request method, (i.e., create a reporting job) if the recipient analytics function 920 is MDAF as described in 3GPP TS 28.104 v17.0.1.

At 982, the recipient analytics function 920 uses the Analytics Request Processing component 930 or Inter-plane Analytics Logic (that resides within the same function or can alternative be a separated NF) to determine the requirements of the received analytics request to identify the inter-plane attributes (as mentioned above: Analytics ID, AI/ML Model ID, Relative time schedule, Reporting time window, etc.).

At 983, the recipient analytics function 920 performs the discovery of the optimal inter-plane analytics function(s) 940. The discovery step can take place in two different ways.

(i) The recipient analytics function 920 requests a centralize repository (e.g., NRF) indicating the desired capabilities for a target inter-plane analytics function 940 in step 983a (based on Analytics ID, AI/ML Model ID, analytics type, load, latency, etc.) and receives reply in step 983b suggesting a set of inter-plane analytics function 940 to select from.

(ii) Alternatively, the recipient analytics function 920 may request from each suggested inter-plane analytics function 940 its capabilities provided that the corresponding IP address is known or discovered, e.g., via DNS. The recipient analytics function 920 is then able to select the optimal inter-plane analytics function 940. The recipient analytics function 920 may elect to request capabilities from each suggested inter-plane analytics function 940 if the recipient analytics function 920 only receives basic information from the centralized repository in steps 983a and 983b.

At 984, if the discovery process does not suggest an inter-plane analytics function 940 that can fulfil the desired capabilities, then the recipient analytics function 920 may optionally negotiate with the analytics consumer 910 the requirements of the analytics request. A negotiation example may include the change of the desired analytics type, e.g., from real-time to near-real time because the relative time schedule does not allow the preparation of an analytics result in real-time. If a solution cannot be reached in the negotiation step or if the negotiation step is not supported at all, then the process is terminated in this step.

At 985, if the suggested set of inter-plane analytics function 940 fulfils the desired capabilities or a negation step assist in reaching a solution, then the recipient analytics function 920 selects the optimal inter-plane analytics functions 940 and formats the corresponding inter-plane analytics request.

At 986, the inter-plane analytics request is issued automatically towards the selected inter-plane analytics function 940.

At 987, the inter-plane analytics function 940 responds providing the desired analytics output results.

At 988, the recipient analytics function 920 collects additionally raw data from other data sources, which may include NFs, MnSs, repository functions, e.g., NRF, UDR, URM, data collection entities, e.g., DCCF, MFAF, ADRF, MADCOL, etc., in order to calculate the consumer request analytics result.

At 989, the recipient analytics function 920 prepares the analytics result, e.g., formatting, etc.

At 990, the recipient analytics function 920 sends an analytics response towards the analytics consumer 910, the analytics response providing the requested analytics.

Typically, the recipient analytics function 920 and the inter-plane analytics function(s) 940 reside on different network planes. However, there can also be the case where both recipient analytics function 920 and inter-plane analytics function(s) 940 reside on the same network plane, but on different domains. This can also be the case, e.g., of the aggregator NWDAF, where instead of pre-configuring its relationship with distributed NWDAFs, this relation can be built on demand considering the analytics requests from consumers. In this case the same method can be applied to process and analyze the consumer request to discover and select the appropriate distributed NWDAFs.

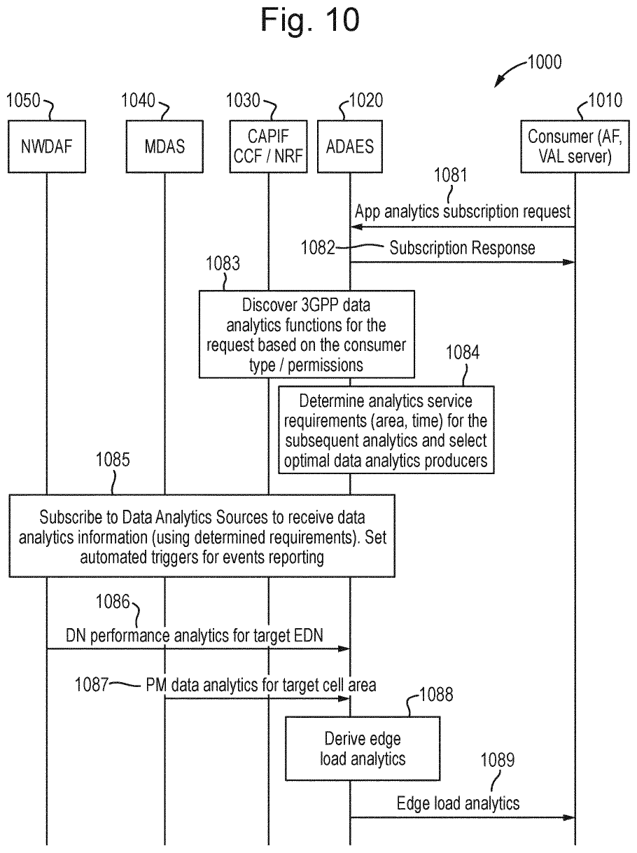

FIG. 10 illustrates a method 1000 of Inter-plane analytics between ADAES and 3GPP domain analytics (OAM and 5GC). FIG. 10 illustrates a consumer 1010, an ADAES 1020, and CAPIF 1030, and MDAS 1040 and an NWDAF 1050. The CAPIF 1030 may be a CCF or an NRF. The Consumer 1010 may comprise an AF or a VAL server. According to method 1000, the inter-plane analytics is performed at ADAES taking as inputs the 3GPP data analytics (NWDAF and/or MDAS). (Note that MDA, MDAF and MDAS can be used interchangeably).

We take as an example the edge load analytics as discussed in 3GPP TS 23.700-36 v0.4.0, where the ADAES uses as input the PM data analytics from OAM and DN performance data analytics from NWDAF to derive the edge load analytics (among other inputs). The method 1000 focuses on the discovery of the analytics service producers (NWDAF 1050, MDAS 1040) and the coordination of parameters to ensure meeting the requirements for the inter-plane service.

At 1081, the consumer of the ADAES analytics service sends a subscription request to ADAES and provides the analytics event ID, e.g., edge performance prediction or stats, the DNN/DNAI, the time validity and area of the request, the required confidence level, whether inter-plane analytics are needed and the AI/ML model type etc.

At 1082, the ADAES sends a subscription response as an ACK to the consumer.

At 1083, the ADAES maps the analytics event ID to a list of data analytics event identifiers (can be pre-configured), and interacts with a service repository function (CAPIF CCF, NRF, ADRF or any other registry at 5GS which can provide the list of analytics functions at the target area and type of request.

The service repository function authorizes the request (also checking whether the end consumer is permitted to consume in-directly the analytics service) and provides the data analytics function IDs and addresses as well as (optionally) API/service load information (e.g., load of NWDAF #1, load of NWDAF API #x)

At 1084, the ADAES determines the analytics service requirements (timing, area, reporting requirements, method, automated trigger event/actions, etc.) per identified analytics source so as to ensure meeting the inter-plane analytics service requirements with the needed confidence level. Such determination also takes into account the possible communication and processing latency of analytics inputs as well as possible priority/hierarchy/reliability of analytics.

At 1085, the ADAES sends a subscription request to the Data Analytics Producers (NWDAF, OAM/MDAS) with the respective Data Analytics Event ID and the requirement for data analytics collection. The Data Analytics Producer(s) sends a subscription response as an ACK to the ADAES.

At 1086-1089, the ADAES collects the reported analytics based on the configuration and derives the app/edge layer analytics and provides the output to the consumer. Steps 1086-1089 may be performed in accordance with 3GPP TR 23.700-36 v0.4.0.

When an analytics function receives a consumer request related to an Analytics ID that relies on the output result of another Analytics ID from an inter-plane analytics function, i.e., NWDAF requires a MDAF Analytics ID output as input data or vice versa, there is provided a means to: (i) identify the appropriate inter-plane analytics function because the desired capabilities need to be analyzed and determined based on the ones contained in the original consumer request, (ii) derive the analytics attribute and formulate new analytics request automatically towards the respective counter plane analytics function.

There is accordingly provided a method to automatically determine the attributes to formulate a subsequent inter-plane analytics request. There is introduced a process inside the analytics function to: (i) map the subsequent Analytics ID, AI/ML Model ID, analytics type, reporting method, area, filtering, (ii) calculate of relative time schedule for reporting, (iii) derive the AI/ML Model input, i.e., reporting time window and analytics samples, (iv) translate one attribute to another, e.g., target UEs to area, (v) identify containment relations, e.g., MnS contained in a NF. The analytics function capabilities may be registered in the repository or may be communicated directly.

The proposed processing of the original consumer request that derives the requirements can be implemented inside NWDAF, allowing an autonomous inter-plane analytics request to be issued towards the corresponding MDA.

Alternatively, processing of the original consumer request that derives the requirements can be implemented inside MDAF, allowing an autonomous inter-plane analytics request to be issued towards the corresponding NWDAF. MDAF can consult NRF to identify the desired NWDAF.

Further, the proposed processing of the original consumer request that derives the requirements can be implemented inside ADAES, allowing an autonomous inter-plane analytics request to be issued towards the corresponding MDAS or NWDAF.

Accordingly, there is provided a method that comprises processing original analytics request from consumer to derive the analytics requirements in order to formulate the new analytics request towards the analytics function on the counter plane. The method may further comprise identifying the appropriate analytics function on the counter plane that would be responsible for providing the complementing analytics. The method may further comprise negotiating requirements with the consumer if the processing and the selection of the optimal analytics function cannot satisfy its original requirements.

There is further provided a method that allows an analytics function, that relies on input from another analytics function to produce its output result, to automatically determine the attributes contain to formulate a subsequent inter-plane analytics request based on the original analytics request from a consumer.

The other analytics function may be an inter-plane analytics function.

The method may allow an analytics function, that relies on input from another inter-plane analytics function to produce its output result, to identify and select automatically the optimal inter-plane analytics function.

The method may enable an analytics function to perform a mapping of the following but not limited attributes including the Analytics ID, AI/ML Model ID, analytics type, reporting method, area, filtering from the original consumer request.

The method may enable an analytics function to perform a mapping based on pre-configured information and/or based on parameter matching.

The method may enable an analytics function to calculate the relative time schedule for reporting considering the CPU and/or storage load in the candidate inter-plane analytics function and the communication latency.

The method may enable an analytics function to derive the format of the AI/ML Model input, considering the reporting time window and analytics samples.

The method may enable an analytics function to translate one attribute type related to target UEs into geographical area and/or translate one attribute type related to geographical area into any UE.

The method may enable an analytics function to identify containment relations, among management services and network function and vice versa.

There is further provided a method that allows an analytics function, that relies on input from another inter-plane analytics function to produce its output result, to automatically negotiate the consumer requirements if the selection of the optimal inter-plane analytics function cannot satisfy them.

There is further provided a method for providing an inter-plane analytics service at a data analytics service producer, the method comprising: —receiving a first requirement for a first analytics service; —determine a second requirement for deriving inter-plane analytics for the first analytics service, wherein the requirement comprises one or more further analytics services from one or more analytics functions; —configure at least one parameter for the one or more further analytics services based on the first and/or the second requirement; —send the at least one parameter to one or more analytics service producers of the one or more further analytics services.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field of the present document: AI/ML, Artificial Intelligence/Machine Learning; ADRF, Analytical Data Repository Function; ADAES, Application Data Analytics Enablement Services; CPU, Central Processing Unit; DCCF, Data Collection Coordination Functionality; DN, Data Network; DNS, Domain Name Server; MADCOL Management Data Collection Control and Discovery; MDA, Management Data Analytics; MFAF, Messaging Framework Adaptor Function; MnS, Management Service; NF, Network Function; NRF, Network Repository Function; NWDAF, Network Data Analytics Function; PLMN, Public Land Mobile Network; PM, Performance Management; QoE, Quality of Experience; RAN, Radio Access Network; SBA, Service Based Architecture; SBMA, Service Based Management Architecture; SLS, Service Level Specification; SUPI, Subscription Permanent Identifier; TA, Tracking Area; UDM, User Data manager; UDR, User Data Repository; and UE, User Equipment.

What is claimed is:

1-15. (canceled)

16. An apparatus for wireless communication, comprising:
at least one memory; and
at least one processor coupled with the at least one memory and configured to cause the apparatus to:
receive, at a first network function, a first analytics request;
transmit, to a second network function and based at least in part on the first analytics request, a second analytics request, wherein the first network function and the second network function are associated with different network planes;
receive, from the second network function, a first analytics response; and
transmit, based at least in part on the first analytics response, a second analytics response.

17. The apparatus of claim 16, wherein the at least one processor is configured to cause the apparatus to determine one or more attributes of the second analytics request based at least in part on the first analytics request.

18. The apparatus of claim 16, wherein the at least one processor is configured to cause the apparatus to receive information of one or more capabilities of the second network function.

19. The apparatus of claim 16, wherein the second analytics request comprises one or more of:
an analytics identifier;
a time schedule;
a reporting time window;
an analytics type;
a reporting method;
a target area;
one or more target network objects; or
one or more reporting filtering conditions.

20. The apparatus of claim 16, wherein the first network function is implemented on a network control plane and the second network function is implemented on a network management plane.

21. The apparatus of claim 16, wherein the first network function comprises a network data analytics function (NWDAF), and the second network function comprises a management data analytics function (MDAF).

22. The apparatus of claim 16, wherein the apparatus is associated with a first network plane, and wherein the at least one processor is configured to cause the apparatus to:
transmit, to a second network plane, a discovery request for one or more analytics capabilities associated with the second network function; and
receive a capability report comprising one or more analytics capabilities of one or more nodes associated with the second network function.

23. The apparatus of claim 22, wherein the second network function is selected based at least in part on the capability report.

24. The apparatus of claim 22, wherein the one or more analytics capabilities of the one or more nodes comprise at least one of an indication of a computational latency, an indication of a communication latency, one or more reporting sample types, or one or more analytics types.

25. A processor for wireless communication, comprising:
at least one controller coupled with at least one memory and configured to cause the processor to:
receive, at a first network function, a first analytics request;
transmit, to a second network function and based at least in part on the first analytics request, a second analytics request, wherein the first network function and the second network function are associated with different network planes;
receive, from the second network function, a first analytics response; and
transmit, based at least in part on the first analytics response, a second analytics response.

26. The processor of claim 25, wherein the at least one controller is configured to cause the processor to determine one or more attributes of the second analytics request based at least in part on the first analytics request.

27. The processor of claim 25, wherein the at least one controller is configured to cause the processor to receive information one or more capabilities of the second network function.

28. The processor of claim 25, wherein the second analytics request comprises one or more of:
an analytics identifier;
a time schedule;
a reporting time window;
an analytics type;
a reporting method;
a target area;
one or more target network objects; or
one or more reporting filtering conditions.

29. The processor of claim 25, wherein the first network function is implemented on a network control plane and the second network function is implemented on a network management plane.

30. The processor of claim 25, wherein the first network function comprises a network data analytics function (NWDAF), and the second network function comprises a management data analytics function (MDAF).

31. The processor of claim 25, wherein the processor is associated with a first network plane, and wherein the at least one controller is configured to cause the processor to:
transmit, to a second network plane, a discovery request for one or more analytics capabilities associated with the second network function; and
receive a capability report comprising one or more analytics capabilities of one or more nodes associated with the second network function.

32. The processor of claim 31, wherein the second network function is selected based at least in part on the capability report.

33. A method performed by an apparatus, the method comprising:
receiving, at a first network function, a first analytics request;
transmitting, to a second network function and based at least in part on the first analytics request, a second analytics request, wherein the first network function and the second network function are associated with different network planes;
receiving, from the second network function, a first analytics response; and
transmitting, based at least in part on the first analytics response, a second analytics response.

34. An apparatus for wireless communication, comprising:
at least one memory; and
at least one processor coupled with the at least one memory and configured to cause the apparatus to:
receive, at a first network function, capability information from a plurality of counterpart nodes, the capability information defining, for each counterpart node, a capability of the counterpart node to generate counterpart analytics, wherein the first network function and at least one of the counterpart nodes are associated with different network planes;
receive, from a second network function, a request for capability information; and
transmit a capability report comprising at least a portion of the capability information.

35. The apparatus of claim 34, wherein the at least one of the counterpart nodes is implemented on a network management plane, and the second network function is implemented on a network control plane.
